(19) United States
(12) Patent Application Publication
(10) Pub. No.: US 2024/0173996 A1
(43) Pub. Date: May 30, 2024

(54) INKJET PRINTER

(71) Applicant: MIMAKI ENGINEERING CO., LTD., Nagano (JP)

(72) Inventor: Ryo Nishizawa, Nagano (JP)

(73) Assignee: MIMAKI ENGINEERING CO., LTD., Nagano (JP)

(21) Appl. No.: 18/283,207

(22) PCT Filed: Mar. 18, 2022
(86) PCT No.: PCT/JP2022/012593

§ 371 Date: Sep. 21, 2023

(30) Foreign Application Priority Data
Apr. 26, 2021 (JP) 2021-073801

(51) Int. Cl. B41J 2/21; B41J 2/14; B41J 2/155

(52) U.S. Cl. CPC B41J 2/2132; B41J 2/155; B41J 2002/14467

(57) ABSTRACT

Provided is an inkjet printer capable of ensuring the print quality of the inkjet printer, the inkjet printer performing bidirectional printing on a print medium by a multi-path method. In this inkjet printer, a plurality of nozzle rows an inkjet head has are each composed of ink-ejecting path rows that eject ink when printing is performed on the print medium, and no-ink-ejecting path rows that do not eject ink when printing is performed on the print medium. Ink-ejecting path rows each disposed at an end on one side in a sub-scanning direction are located shifted to each other in the sub-scanning direction. Alternately, specific path rows, each of which ejects ink greater in amount than ink ejected by each of the other ink-ejecting path rows in each nozzle row, are located shifted to each other in the sub-scanning direction.

### TECHNICAL FIELD

The present invention relates to an inkjet printer that performs bidirectional printing on a print medium by a multi-path method.

### BACKGROUND ART

Conventionally, an inkjet printer that performs printing on a print medium by a multi-path method is known (see, for example. Patent Literature 1). The inkjet printer described in Patent Literature 1 includes four inkjet heads that eject ink, a carriage carrying the four inkjet heads, a carriage drive mechanism that moves the carriage in a main scanning direction, and a medium feeding mechanism that feeds the print medium in a sub-scanning direction. Each inkjet head has one nozzle row composed of a plurality of nozzles arranged in the sub-scanning direction, and therefore four inkjet heads mounted on the carriage have four nozzle rows in total. The four nozzle rows the four inkjet heads have are lined up in the main scanning direction and are arranged at the same position in the sub-scanning direction. The nozzle row is composed of, for example, four path rows segmented at a given bandwidth.

In the inkjet printer described in Patent Literature 1, a printing region, which is a region where printing on the print medium is performed, is composed of a plurality of segmented printing regions created by segmenting the printing region at the bandwidth in the sub-scanning direction. In this inkjet printer, printing is performed, for example, in four paths in each segmented printing region. Specifically, in this inkjet printer, for example, bidirectional printing is performed on the print medium such that an operation of moving the carriage to one side in the main scanning direction, an operation of feeding the print medium in the sub-scanning direction relative to the carriage, an operation of moving the carriage to the other side in the main scanning direction, and an operation of feeding the print medium in the sub-scanning direction relative to the carriage are carried out in descending order repeatedly to perform printing in each segmented printing region four times. When printing has been performed in each segmented printing region four times, therefore, printing in each segmented printing region is completed.

In the inkjet printer described in Patent Literature 1, when randomly selected one segmented printing region among the plurality of segmented printing regions is defined as a first segmented printing region and a segmented printing region adjacent to the first segmented printing region in the sub-scanning direction is defined as a second segmented printing region, the carriage of this inkjet printer moves to the one side in the main scanning direction at the time of printing in the first path and printing in the third path that are performed in the first segmented printing region, and moves to the other side in the main scanning direction at the time of printing in the second path and printing in the fourth path that are performed in the first segmented printing region. In contrast, at the time of printing in the first path and printing in the third path that are performed in the second segmented printing region, the carriage moves to the other side in the main scanning direction, and at the time of printing in the second path and printing in the fourth path that are performed in the second segmented printing region, the carriage moves to the one side in the main scanning direction.

### CITATION LIST

### Patent Literature

Patent Literature 1: Japanese Unexamined Patent Publication No. 2020-62788

### SUMMARY OF INVENTION

### Technical Problems

In the inkjet printer described in Patent Literature 1, a direction in which the carriage moves at the time of printing in the first path performed in the first segmented printing region and a direction in which the carriage moves at the time of printing in the first path performed in the second segmented printing region are reverse to each other. Similarly, in this inkjet printer, a direction in which the carriage moves at the time of printing in the second path and printing in the fourth path that are performed in the first segmented printing region and a direction in which the carriage moves at the time of printing in the second path and printing in the fourth path that are performed in the second segmented printing region are reverse to each other. As a result, in the case of the inkjet printer described in Patent Literature 1, the order of landing of jets of ink in the first segmented printing region, the jets of ink being ejected respectively from the four nozzle rows lined up in the main scanning direction, and the same in the second segmented printing region are reverse to each other.

In the inkjet printer described in Patent Literature 1, therefore, a case of the four nozzle rows' ejecting color inks different in color from each other, for example, raises a concern that a color shade in the first segmented printing region after completion of printing and a color shade in the second segmented printing region after completion of printing may become different from each other. Specifically, in this inkjet printer, the case of the four nozzle rows' ejecting color inks different in color from each other, for example, raises a concern that color changing, which refers to creation of a difference in color shade between segmented printing regions adjacent to each other in the sub-scanning direction, may occur and consequently ensuring the print quality becomes impossible.

The present invention provides an inkjet printer capable of ensuring the print quality of the inkjet printer, the inkjet printer repeatedly carrying out an operation of moving a carriage to one side in a main scanning direction, an operation of feeding a print medium in a sub-scanning direction relative to the carriage, an operation of moving the carriage to the other side in the main scanning direction, and an operation of feeding the print medium in the sub-scanning direction relative to the carriage, thereby performing bidirectional printing on the print medium by a multi-path method.

### Solutions to Problems

In order to solve the above problem, an inkjet printer of the present invention includes: M inkjet heads, M being 1 or more, that have a plurality of nozzles capable of ejecting ink toward a print medium; a carriage carrying the M inkjet heads mounted thereon; a carriage drive mechanism that moves the carriage in a main scanning direction; and a feeding mechanism that feeds the print medium in a sub-scanning direction perpendicular to a vertical direction and the main scanning direction, relative to the carriage. The inkjet printer repeatedly carries out an operation of moving the carriage to one side in the main scanning direction, an operation of feeding the print medium in the sub-scanning direction relative to the carriage, an operation of moving the carriage to the other side in the main scanning direction, and an operation of feeding the print medium in the sub-scanning direction relative to the carriage, thereby performing printing on the print medium by a multi-path method. Each inkjet head has a nozzle row composed of a plurality of nozzles arranged in the sub-scanning direction. The M inkjet heads mounted on the carriage have N nozzle rows in total, N being 2 or more. The N nozzle rows are lined up in the main scanning direction and are arranged at the same position in the sub-scanning direction. Each of the nozzle row is composed of a plurality of N or more path rows segmented at a given bandwidth in the sub-scanning direction, and is composed of ink-ejecting path rows that are the path rows that eject ink when printing is performed on the print medium and no-ink-ejecting path rows that are the path rows that do not eject ink when printing is performed on the print medium. When printing is performed on the print medium, the feeding mechanism feeds the print medium by a distance equal to the bandwidth in the sub-scanning direction, relative to the carriage. The N nozzle rows each have the same number of the ink-ejecting path rows. When the N nozzle rows each have a plurality of the ink-ejecting path rows, the ink-ejecting path rows are entirely arranged as a string of path rows in the sub-scanning direction in each of the N nozzle rows. When the ink-ejecting path row disposed at an end on one side in the sub-scanning direction in each of the N nozzle rows is defined as a one-end-side path row, respective one-end-side path rows of the N nozzle rows are located shifted to each other in the sub-scanning direction.

In the inkjet printer of the present invention, the nozzle row each inkjet head has is composed of the ink-ejecting path row that is the path row that ejects ink when printing is performed on the print medium and the no-ink-ejecting path row that is the path row that does not eject ink when printing is performed on the print medium, and the N nozzle rows each have the same number of the ink-ejecting path rows. In addition, according to the present invention, when the ink-ejecting path row disposed at the end on the one side in the sub-scanning direction in each of the N nozzle rows is defined as the one-end-side path row, respective one-end-side path rows of the N nozzle rows are located shifted to each other in the sub-scanning direction.

As a result, when the first segmented printing region and the second segmented printing region are defined in the above manner, according to the present invention, the order of landing of jets of ink in the first segmented printing region and the same in the second segmented printing region after completion of printing by the multi-path method do not match completely, but in an overall view of the first segmented printing region and the second segmented printing region after completion of printing by the multi-path method, the order of landing of jets of ink in the first segmented printing region and the same in the second segmented printing region can be bright closer to each other. According the present invention, therefore, a difference between a color shade in the first segmented printing region after completion of printing and a color shade in the second segmented printing region after completion of printing can be reduced. Hence, according to the present invention, the occurrence of color changing. i.e., creation of a difference in color shade between segmented printing regions adjacent to each other in the sub-scanning direction, can be prevented and therefore the print quality of the inkjet printer can be ensured.

In addition, according to the present invention, because respective one-end-side path rows of the N nozzle rows are located shifted to each other in the sub-scanning direction, a path with fewer ink-ejecting nozzle rows arises among N paths for performing printing in each segmented printing region. According to the present invention, occurrence of color mixing in a path with fewer ink-ejecting nozzle rows can be prevented.

By arranging the plurality of nozzle rows shifted to each other in the sub-scanning direction (i.e., arranging the plurality of nozzle rows in a staggered pattern), the order of landing of jets of ink in the first segmented printing region and the same in the second segmented printing region after completion of printing by the multi-path method can be completely matched to each other. In this case, however, the size of the carriage in the sub-scanning direction increases. In addition, in this case, printing on the print medium takes much time.

According to the present invention, it is preferable that the nozzle row be composed of N+2 or more path rows and each of the N nozzle rows include three or more ink-ejecting path rows, that in each of the N nozzle rows, when, among the plurality of ink-ejecting path rows, an ink-ejecting path row disposed at an end on the other side in the sub-scanning direction is defined as an other-end-side path row and a given ink-ejecting path row disposed between the one-end-side path row and the other-end-side path row in the sub-scanning direction is defined as a specific path row, in each of the N nozzle rows, the amount of ink ejected by the specific path row be larger than the amount of ink ejected by each of the other ink-ejecting path rows not including the specific path row and the amount of ink ejected by the ink-ejecting path row increase gradually as it goes from the one-end-side path row toward the specific path row but the amount of ink ejected by the ink-ejecting path row decreases gradually as it goes from the specific path row toward the other-end-side path row, and that respective specific path rows of the N nozzle rows be located shifted to each other in the sub-scanning direction and be shifted in the same order in which respective one-end-side path rows of the N nozzle rows are shifted in the sub-scanning direction.

In this configuration, in an overall view of the first segmented printing region and the second segmented printing region after completion of printing by the multi-path method, the order of landing of jets of ink in the first segmented printing region and the same in the second segmented printing region can be further bright closer to each other. A difference between a color shade in the first segmented printing region after completion of printing and a color shade in the second segmented printing region after completion of printing, therefore, can be further reduced. Hence the occurrence of color changing. i.e., creation of a difference in color shade between different segmented printing regions, can be further prevented and therefore the print quality of the inkjet printer can be improved.

In this configuration, because respective specific path rows of the N nozzle rows are located shifted to each other in the sub-scanning direction, the occurrence of color mixing at ink ejection by the specific path rows can be prevented more effectively than a case where respective specific path rows of the N nozzle rows are located at the same position in the sub-scanning direction.

According to the present invention, when a side to which the print medium moves relative to the carriage is defined as a first direction side, for example, M inkjet heads have, as the nozzle rows, a dark ink nozzle row that ejects color ink of a relatively dark color and a light ink nozzle row that ejects color ink of a relatively light color, and the one-end-side path row of the dark ink nozzle row is disposed closer to the first direction side than the one-end-side path row of the light ink nozzle row. In this case, ink of the relatively dark color greater in amount than ink of the relatively light color can be located on a side closer to the surface of an image having been printed. An image with a clear outline or the like, therefore, can be printed on the print medium.

According to the present invention, when a side to which the print medium moves relative to the carriage is defined as a first direction side. M inkjet heads may have, as the nozzle rows, a dark ink nozzle row that ejects color ink of a relatively dark color and a light ink nozzle row that ejects color ink of a relatively light color, and the one-end-side path row of the light ink nozzle row may be disposed closer to the first direction side than the one-end-side path row of the dark ink nozzle row. In this case, ink of the relatively light color greater in amount than ink of the relatively dark color can be located on a side closer to the surface of an image having been printed. A fuzzy image, in which the grainy texture of ink is suppressed, can be printed on the print medium.

In order to solve the above problem, an inkjet printer of the present invention includes: M inkjet heads, M being 1 or more, that have a plurality of nozzles capable of ejecting ink toward a print medium; a carriage carrying the M inkjet heads mounted thereon; a carriage drive mechanism that moves the carriage in a main scanning direction; and a feeding mechanism that feeds the print medium in a sub-scanning direction perpendicular to a vertical direction and the main scanning direction, relative to the carriage. The inkjet printer repeatedly carries out an operation of moving the carriage to one side in the main scanning direction, an operation of feeding the print medium in the sub-scanning direction relative to the carriage, an operation of moving the carriage to the other side in the main scanning direction, and an operation of feeding the print medium in the sub-scanning direction relative to the carriage, thereby performing printing on the print medium by a multi-path method. Each inkjet head has a nozzle row composed of a plurality of nozzles arranged in the sub-scanning direction. The M inkjet heads mounted on the carriage have N nozzle rows in total. N being 2 or more. The N nozzle rows are lined up in the main scanning direction and are arranged at the same position in the sub-scanning direction. Each of the nozzle rows is composed of a plurality of N+2 or more path rows segmented at a given bandwidth in the sub-scanning direction, and has three or more ink-ejecting path rows that are the path rows that eject ink when printing is performed on the print medium. When printing is performed on the print medium, the feeding mechanism feeds the print medium by a distance equal to the bandwidth in the sub-scanning direction, relative to the carriage. In each of the N nozzle rows, when, among the plurality of ink-ejecting path rows, an ink-ejecting path row disposed at an end on one side in the sub-scanning direction is defined as a one-end-side path row, an ink-ejecting path row disposed at an end on the other side in the sub-scanning direction is defined as an other-end-side path row, and a given ink-ejecting path row disposed between the one-end-side path row and the other-end-side path row in the sub-scanning direction is defined as a specific path row, in each of the N nozzle rows, the amount of ink ejected by the specific path row is larger than the amount of ink ejected by each of the other ink-ejecting path rows not including the specific path row and the amount of ink ejected by the ink-ejecting path row increases gradually as it goes from the one-end-side path row toward the specific path row but the amount of ink ejected by the ink-ejecting path row decreases gradually as it goes from the specific path row toward the other-end-side path row. Respective specific path rows of the N nozzle rows are located shifted to each other in the sub-scanning direction.

In the inkjet printer of the present invention, the nozzle row the inkjet head has includes three or more ink-ejecting path rows that are path rows that eject ink when printing is performed on the print medium. According to the present invention, in each of the N nozzle rows, when, among the plurality of ink-ejecting path rows, the ink-ejecting path row disposed at the end on the one side in the sub-scanning direction is defined as the one-end-side path row, the ink-ejecting path row disposed at the end on the other side in the sub-scanning direction is defined as the other-end-side path row, and the given ink-ejecting path row disposed between the one-end-side path row and the other-end-side path row in the sub-scanning direction is defined as the specific path row, in each of the N nozzle rows, the amount of ink ejected by the specific path row is larger than the amount of ink ejected by each of the other ink-ejecting path rows not including the specific path row and the amount of ink ejected by the ink-ejecting path row increases gradually as it goes from the one-end-side path row toward the specific path row but the amount of ink ejected by the ink-ejecting path row decreases gradually as it goes from the specific path row toward the other-end-side path row. According to the present invention, respective specific path rows of the N nozzle rows are located shifted to each other in the sub-scanning direction.

As a result, when the first segmented printing region and the second segmented printing region are defined in the above manner, according to the present invention, the order of landing of jets of ink in the first segmented printing region and the same in the second segmented printing region after completion of printing by the multi-path method do not match completely, but in an overall view of the first segmented printing region and the second segmented printing region after completion of printing by the multi-path method, the order of landing of jets of ink in the first segmented printing region and the same in the second segmented printing region can be bright closer to each other. According the present invention, therefore, a difference between a color shade in the first segmented printing region after completion of printing and a color shade in the second segmented printing region after completion of printing can be reduced. Hence, according to the present invention, the occurrence of color changing. i.e., creation of a difference in color shade between segmented printing regions adjacent to each other in the sub-scanning direction, can be prevented and therefore the print quality of the inkjet printer can be ensured.

According to the present invention, because respective specific path rows of the N nozzle rows are located shifted to each other in the sub-scanning direction, the occurrence of color mixing at ink ejection by the specific path rows can be prevented more effectively than a case where respective specific path rows of the N nozzle rows are located at the same position in the sub-scanning direction.

According to the present invention, for example M inkjet heads mounted on the carriage have four nozzle rows in total, which eject color inks different in color from each other.

### Effect of the Invention

As described above, according to the present invention, the print quality of an inkjet printer can be ensured, the inkjet printer repeatedly carrying out an operation of moving a carriage to one side in a main scanning direction, an operation of feeding a print medium in a sub-scanning direction relative to the carriage, an operation of moving the carriage to the other side in the main scanning direction, and an operation of feeding the print medium in the sub-scanning direction relative to the carriage, thereby performing bidirectional printing on the print medium by a multi-path method.

### BRIEF DESCRIPTION OF THE DRAWINGS

FIG. 1 is a schematic diagram for explaining a configuration of an inkjet printer according to an embodiment of the present invention.

FIG. 2 is a schematic diagram for explaining a configuration of inkjet heads shown in FIG. 1.

FIG. 3 is a schematic view for explaining a configuration of nozzle rows shown in FIG. 2.

FIG. 4 is a diagram for explaining an operation the inkjet printer shown in FIG. 1 carries out during printing.

FIG. 5 is a diagram for explaining an operation the inkjet printer shown in FIG. 1 carries out during printing.

FIG. 6 is a diagram for explaining an operation the inkjet printer shown in FIG. 1 carries out during printing.

FIG. 7 is a diagram for explaining an operation the inkjet printer shown in FIG. 1 carries out during printing.

(A) of FIG. 8 is a diagram for explaining the order of landing of jets of ink on specific parts of segmented printing regions shown in FIGS. 4 to 7, and (B) of FIG. 8 is a diagram for explaining an effect of the inkjet printer shown in FIG. 1.

FIG. 9 is a schematic diagram for explaining a configuration of nozzle rows according to a reference example of the present invention.

FIG. 10 is a schematic diagram for explaining a configuration of nozzle rows according to another embodiment of the present invention.

FIG. 11 is a schematic diagram for explaining a configuration of nozzle rows according to still another embodiment of the present invention.

FIG. 12 is a schematic diagram for explaining a configuration of nozzle rows according to still another embodiment of the present invention.

### DESCRIPTION OF EMBODIMENTS

Embodiments of the present invention will hereinafter be described with reference to the drawings.

### (Schematic Configuration of Inkjet Printer)

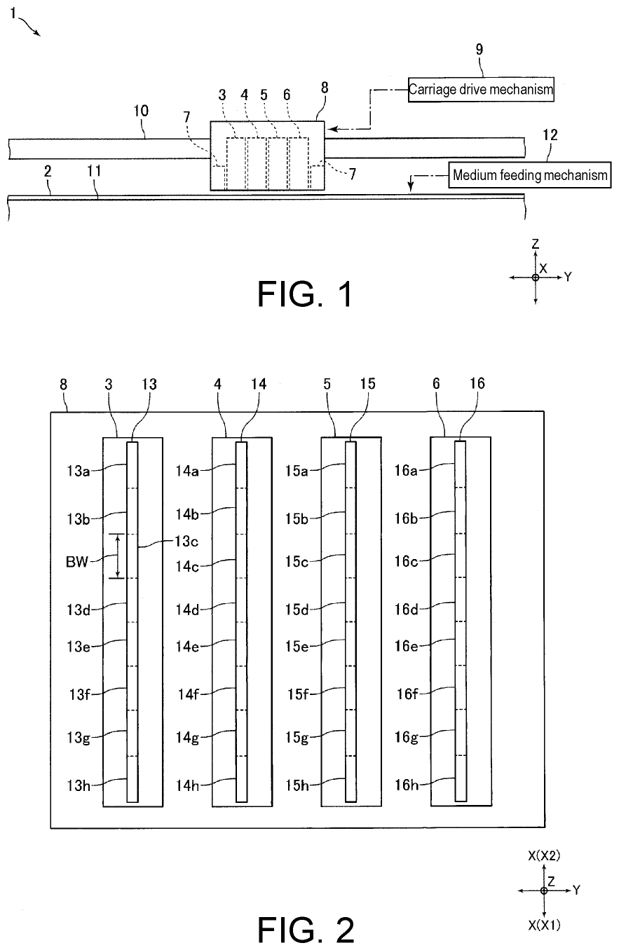

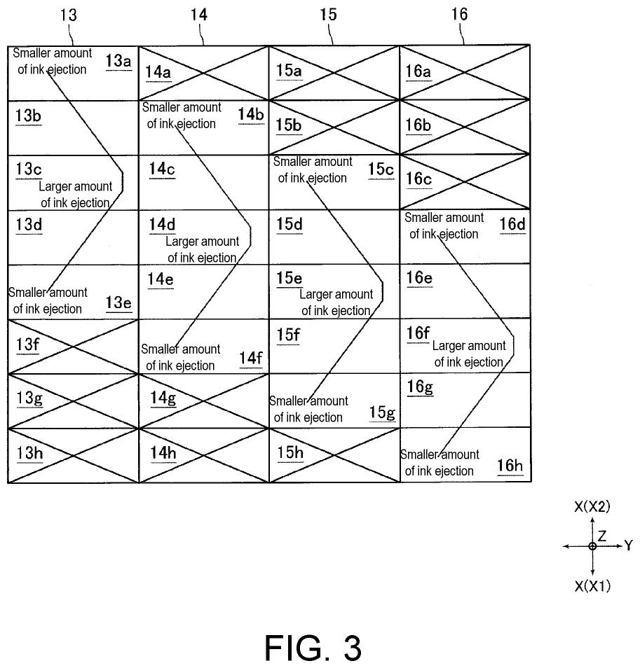

FIG. 1 is a schematic diagram for explaining a configuration of an inkjet printer 1 according to an embodiment of the present invention. FIG. 2 is a schematic diagram for explaining a configuration of inkjet heads 3 to 6 shown in FIG. 1.

An inkjet printer 1 (which will hereinafter be referred to as a “printer 1”) of this embodiment is, for example, an inkjet printer for business use, and performs printing on a print medium 2. The print medium 2 is, for example, a print sheet, a fabric, a resin film, or the like. The printer 1 includes inkjet heads 3 to 6 (which will hereinafter be referred to as “heads 3 to 6”) that eject ink. The printer 1 of this embodiment includes a plurality of heads 3 to 6. Specifically, the printer 1 includes four heads 3 to 6. The head 3 to 6 eject ink of an ultraviolet curing type (UV ink).

The printer 1 further includes ultraviolet irradiators 7 that irradiate ink ejected from the heads 3 to 6 with ultraviolet light to cure the ink, a carriage 8 carrying the four heads 3 to 6 and the ultraviolet irradiator 7, a carriage drive mechanism 9 that moves the carriage 8 in a main scanning direction (Y direction shown in FIG. 1, etc.), a guide rail 10 that guides the carriage 8 in the main scanning direction, a platen 11 on which the print medium 2 is placed at the time of printing, and a medium feeding mechanism 12 that feeds the print medium 2 in a sub-scanning direction (X direction shown in FIG. 1, etc.) perpendicular to a vertical direction (Z direction shown in FIG. 1, etc.) and the main scanning direction. The medium feeding mechanism 12 of this embodiment is a feeding mechanism that feeds the print medium 2 in the sub-scanning direction relative to the carriage 8.

The printer 1 may include a guide shaft provided in place of the guide rail 10. The printer 1 may include a table on which the print medium 2 is placed, and a table feeding mechanism that feeds the table in the sub-scanning direction, the table and table feeding mechanism being provided in place of the platen 11 and medium feeding mechanism 12, respectively. In this case, the table feeding mechanism is a feeding mechanism that feeds the print medium 2 in the sub-scanning direction relative to the carriage 8. The printer 1 may include a table on which the print medium 2 is placed, and a carriage feeding mechanism that feeds the carriage 8, together with the guide rail 10, in the sub-scanning direction, the table and carriage feeding mechanism being provided in place of the platen 11 and medium feeding mechanism 12, respectively. In this case, the carriage feeding mechanism is a feeding mechanism that feeds the print medium 2 in the sub-scanning direction relative to the carriage 8.

The printer 1 of this embodiment alternately carries out an operation of moving the carriage 8 in the main scanning direction and an operation of feeding the print medium 2 in the sub-scanning direction multiple times to perform printing on the print medium 2 by a multi-path method. Specifically, the printer 1 repeatedly carries out an operation of moving the carriage 8 to one side in the main scanning direction, an operation of feeding the print medium 2 in the sub-scanning direction, an operation of moving the carriage 8 to the other side in the main scanning direction, and an operation of feeding the print medium 2 in the sub-scanning direction, thereby performing printing on the print medium 2 by the multi-path method. In other words, the heads 3 to 6 eject ink at the time of moving the carriage 8 to the one side in the main scanning direction and at the time of moving the carriage 8 to the other side in the main scanning direction as well. The printer 1 thus performs bidirectional printing on the print medium 2.

In the following description, the main scanning direction (Y direction) is defined as a “left-to-right direction”, and the sub-scanning direction (X direction) is defined as a “front-to-rear direction”. An X1 direction side shown in FIG. 2, etc., which is one side in the front-to-rear direction, is defined as a “front” side, and an X2 direction side shown in FIG. 2, etc., which is the side opposite to the X1 direction side, is defined as a “rear” side. In this embodiment, the print medium 2 is fed to the front side when printing is performed on the print medium 2. In other words, the front side (X1 direction side) in this embodiment is a first direction side to which the print medium 2 moves relative to the carriage 8.

The carriage drive mechanism 9 includes, for example, two pulleys, a belt stretched between the two pulleys and partially fixed to the carriage 8, and a motor that rotates the pulleys. The carriage 8 is disposed above the platen 11. As described above, the carriage 8 carries four heads 3 to 6 mounted thereon. The four heads 3 to 6 are mounted on the carriage 8 such that they are adjacent to each other in the left-to-right direction. In other words, the four heads 3 to 6 are arranged in the left-to-right direction. The four heads 3 to 6 are arranged in increasing order from one side to the other side in the left-to-right direction. The four heads 3 to 6 are located at the same position in the front-to-rear direction.

The ultraviolet irradiators 7 are mounted on the carriage 8 at both sides of the heads 3 to 6 in the left-to-right direction. In other words, two ultraviolet irradiators 7 are mounted on the carriage 8. Each ultraviolet irradiator 7 includes, for example, a plurality of light-emitting elements, and a substrate carrying the plurality of light-emitting elements. The light emitting elements are, for example, UV LED chips that emit ultraviolet light. The number of the ultraviolet irradiators 7 mounted on the carriage 8 may be 1. Ink ejected from the heads 3 to 6 may be ink of a type different from the ultraviolet curing type. In such a case, the ultraviolet irradiators 7 are unnecessary.

The heads 3 to 6 mounted on the carriage 8 eject ink toward an upper surface of the print medium 2 placed on the platen 11. In other words, the heads 3 to 6 eject ink downward. On lower surfaces of the heads 3 to 6, a plurality of nozzles capable of ejecting ink toward the print medium 2 are formed. The heads 3 to 6 includes a plurality of piezoelectric elements that cause the plurality of nozzles to eject ink, respectively. The piezoelectric elements are controlled by a head controller that controls the heads 3 to 6. For example, the piezoelectric elements are under pulse width modulation (PWM) control.

The plurality of nozzles formed on the heads 3 to 6 are arranged in the front-to-rear direction such that the plurality of nozzles make up nozzle rows 13 to 16. In other words, the heads 3 to 6 have the nozzle rows 13 to 16 composed of the plurality of nozzles arranged in the sub-scanning direction. Specifically, the head 3, the head 4, the head 5, and the head 6 have one nozzle row 13, one nozzle row 14, one nozzle row 15, and one nozzle row 16, respectively. In other words, the four heads 3 to 6 mounted on the carriage 8 have four nozzle rows 13 to 16 in total. The nozzle rows 13 to 16 are composed of, for example, 320 nozzles. The nozzle rows 13 to 16 are equal in length to each other in the front-to-rear direction. The four nozzle rows 13 to 16 are lined up in the left-to-right direction. The four nozzle rows 13 to 16 are located at the same position in the left-to-right direction.

The nozzle rows 13 to 16 eject color inks (colored inks) different in color from each other. In other words, the four heads 3 to 6 have the four nozzle rows 13 to 16 that eject color inks different in color from each other. In this embodiment, the nozzle row 13 ejects ink colored in cyan (C), the nozzle row 14 ejects ink colored in magenta (M), the nozzle row 15 ejects ink colored in yellow (Y), and the nozzle row 16 ejects ink colored in black (K).

As described above, the printer 1 performs printing on the print medium 2 by the multi-path method. For example, the printer 1 performs printing on the print medium 2 in 8 paths, 16 paths, or 32 paths. Hereinafter, a configuration of the nozzle rows 13 to 16 in a case where the printer 1 performs printing on the print medium 2 in 8 paths will be described.

The nozzle row 13 is composed of a plurality of path rows 13a to 13h segmented at a given bandwidth BW in the front-to-rear direction (sub-scanning direction). Because the printer 1 performs printing on the print medium 2 in 8 paths, the nozzle row 13 is segmented into 8 path rows 13a to 13h. In other words, the nozzle row 13 is composed of 8 path rows 13a to 13h. In the same manner, the nozzle row 14 is composed of 8 path rows 14a to 14h segmented at the bandwidth BW in the front-to-rear direction, the nozzle row 15 is composed of 8 path rows 15a to 15h segmented at the bandwidth BW in the front-to-rear direction, and the nozzle row 16 is composed of 8 path rows 16a to 16h segmented at the bandwidth BW in the front-to-rear direction. A more specific configuration of the nozzle rows 13 to 16 will be described later.

The medium feeding mechanism 12 includes, for example, a driving roller that comes into contact with one surface of the print medium 2, a driven roller that is set counter to the driving roller and that comes into contact with the other surface of the print medium 2, and a motor that rotates the driving roller. The medium feeding mechanism 12 feeds the print medium 2 in the sub-scanning direction by the distance equal to the bandwidth BW at the time of printing on the print medium 2. Specifically, the medium feeding mechanism 12 feeds the print medium 2 to the front side by the distance equal to the bandwidth BW at the time of printing on the print medium 2.

### (Configuration of Nozzle Row)

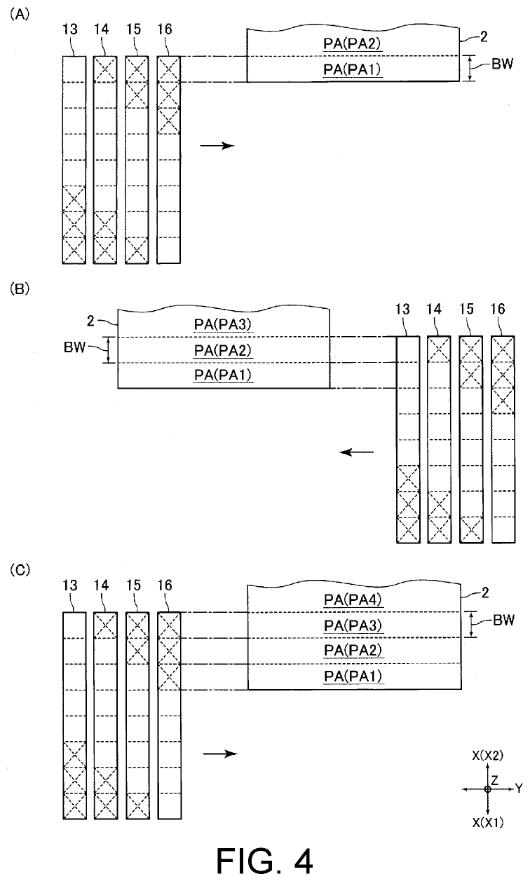

FIG. 3 is a schematic view for explaining a configuration of the nozzle rows 13 to 16 shown in FIG. 2.

As described above, the nozzle row 13 is composed of 8 path rows 13a to 13h, the nozzle row 14 is composed of 8 path rows 14a to 14h, the nozzle row 15 is composed of 8 path rows 15a to 15h, and the nozzle row 16 is composed of 8 path rows 16a to 16h. The path rows 13a to 13h, the path rows 14a to 14h, the path rows 15a to 15h, and the path rows 16a to 16h are each composed of a plurality of nozzles.

The path rows 13a to 13h are arranged in the alphabetical order from the rear side to the front side, and the path row 13a makes up a rear end of the nozzle row 13 as the path row 13h makes up a front end of the nozzle row 13. In the same manner, the path rows 14a to 14h, the path rows 15a to 15h, and the path rows 16a to 16h are each arranged in the alphabetical order from the rear side to the front side, and the path rows 14a. 15a, and 16a make up rear ends of the nozzle rows 14, 15, and 16 as the path rows 14h, 15h, and 16h make up front ends of the nozzle rows 14, 15, and 16, respectively.

The path rows 13a to 13e, 14b to 14f, 15c to 15g, and 16d to 16h eject ink when printing is performed on the print medium 2 in a given printing mode. The path rows 13f to 13h, 14a, 14g. 14h, 15a, 15b, 15h, and 16a to 16c, in contrast, do not eject ink when printing is performed on the print medium 2 in the given printing mode. In other words, when printing is performed on the print medium 2 in the given printing mode, nozzles making up the path rows 13f to 13h, 14a, 14g. 14h, 15a, 15b, 15h, and 16a to 16c are masked and no voltage is applied to the piezoelectric elements corresponding to the nozzles making up the path rows 13f to 13h, 14a. 14g. 14h, 15a, 15b, 15h, and 16a to 16c.

The path rows 13a to 13e. 14b to 14f, 15c to 15g, and 16d to 16h of this embodiment serve as ink-ejecting path rows that eject ink at the time of printing on the print medium 2, while the path rows 13f to 13h. 14a, 14g. 14h, 15a, 15b, 15h, and 16a to 16c serve as no-ink-ejecting path rows that do not eject ink at the time of printing on the print medium 2. Each of the nozzle rows 13 to 16 includes five ink-ejecting path rows. In other words, each of the four nozzle rows 13 to 16 includes the same number of ink-ejecting path rows.

The nozzle row 13 is composed of the path rows 13a to 13e serving as ink-ejecting path rows and the path rows 13f to 13h serving as no-ink-ejecting path rows. The nozzle row 14 is composed of the path rows 14b to 14f serving as ink-ejecting path rows and the path rows 14a. 14g, and 14h serving as no-ink-ejecting path rows, the nozzle row 15 is composed of the path rows 15c to 15g serving as ink-ejecting path rows and the path rows 15a, 15b, and 15h serving as no-ink-ejecting path rows, and the nozzle row 16 is composed of the path rows 16d to 16h serving as ink-ejecting path rows and the path rows 16a to 16c serving as no-ink-ejecting path rows.

In the nozzle row 13, the path rows 13a to 13e serving as the ink-ejecting path rows are arranged as a string of path rows in the front-to-rear direction, that is, arranged continuously in the front-to-rear direction, and no no-ink-ejecting path row is disposed between the path rows 13a to 13e serving as the ink-ejecting path rows. Similarly, in the nozzle row 14, the path rows 14b to 14f serving as the ink-ejecting path rows are arranged as a string of path rows in the front-to-rear direction. In the nozzle row 15, the path rows 15c to 15g serving as the ink-ejecting path rows are arranged as a string of path rows in the front-to-rear direction. In the nozzle row 16, the path rows 16d to 16h serving as the ink-ejecting path rows are arranged as a string of path rows in the front-to-rear direction. In short, in each of the four nozzle rows 13 to 16, all the ink-ejecting path rows are arranged as a string of path rows in the front-to-rear direction.

In the nozzle row 13 (that is, in the head 3), the amount of ink ejected by the path row 13c is larger than the amount of ink ejected by each of the path rows 13a. 13b. 13d, and 13e. The amount of ink ejected by each of the path rows 13a to 13c gradually increases as it goes from the path row 13a toward the path row 13c, and the amount of ink ejected by each of the path rows 13c to 13e gradually decreases as it goes from the path row 13c toward the path row 13e. In this embodiment, for example, the amount of ink ejected by the path row 13a is equal to the amount of ink ejected by the path row 13e, and the amount of ink ejected by the path row 13b is equal to the amount of ink ejected by the path row 13d.

In the nozzle row 14 (that is, in the head 4), the amount of ink ejected by the path row 14d is larger than the amount of ink ejected by each of the path rows 14b. 14c. 14e, and 14f. The amount of ink ejected by each of the path rows 14b to 14d gradually increases as it goes from the path row 14b toward the path row 14d, and the amount of ink ejected by each of the path rows 14d to 14f gradually decreases as it goes from the path row 14d toward the path row 14f. In this embodiment, for example, the amount of ink ejected by the path row 14b is equal to the amount of ink ejected by the path row 14f, and the amount of ink ejected by the path row 14c is equal to the amount of ink ejected by the path row 14e.

In the nozzle row 15 (that is, in the head 5), the amount of ink ejected by the path row 15e is larger than the amount of ink ejected by each of the path rows 15c, 15d, 15f, and 15g. The amount of ink ejected by each of the path rows 15c to 15e gradually increases as it goes from the path row 15c toward the path row 15e, and the amount of ink ejected by each of the path rows 15e to 15g gradually decreases as it goes from the path row 15e toward the path row 15g. In this embodiment, for example, the amount of ink ejected by the path row 15c is equal to the amount of ink ejected by the path row 15g, and the amount of ink ejected by the path row 15d is equal to the amount of ink ejected by the path row 15f.

In the nozzle row 16 (that is, in the head 6), the amount of ink ejected by the path row 16f is larger than the amount of ink ejected by each of the path rows 16d. 16e, 16g, and 16h. The amount of ink ejected by each of the path rows 16d to 16f gradually increases as it goes from the path row 16d toward the path row 16f, and the amount of ink ejected by each of the path rows 16f to 16h gradually decreases as it goes from the path row 16f toward the path row 16h. In this embodiment, for example, the amount of ink ejected by the path row 16d is equal to the amount of ink ejected by the path row 16h, and the amount of ink ejected by the path row 16e is equal to the amount of ink ejected by the path row 16g.

In addition, the amount of ink ejected by the path row 13c, the amount of ink ejected by the path row 14d, the amount of ink ejected by the path row 15e, and the amount of ink ejected by the path row 16f are equal to each other, the amount of ink ejected by the path row 13a, the amount of ink ejected by the path row 14b, the amount of ink ejected by the path row 15c, and the amount of ink ejected by the path row 16d are equal to each other, and the amount of ink ejected by the path row 13b, the amount of ink ejected by the path row 14c, the amount of ink ejected by the path row 15d, and the amount of ink ejected by the path row 16e are equal to each other.

The amount of ink ejected by each of the path rows 13a to 13e is adjusted by adjusting the on/off time ratio (duty ratio) of a voltage applied to piezoelectric elements corresponding to nozzles making up each of the path rows 13a to 13e or adjusting the number of ink-ejecting nozzles among the nozzles making up each of the path rows 13a to 13e. The amount of ink ejected by each of the path rows 14b to 14f, the amount of ink ejected by each of the path rows 15c to 15g, and the amount of ink ejected by each of the path rows 16d to 16h are also adjusted in the same manner as described above.

In each of the four nozzle rows 13 to 16, when, among the plurality of ink-ejecting path rows, an ink-ejecting path row disposed at an end on one side in the sub-scanning direction (specifically, disposed at an end on the rear side) is defined as a one-end-side path row and an ink-ejecting path row disposed at an end on the other side in the sub-scanning direction (specifically, disposed at an end on the front side) is defined as an other-end-side path row, in the nozzle row 13, the path row 13a is the one-end-side path row and the path row 13e is other-end-side path row. In the nozzle row 14, the path row 14b is the one-end-side path row and the path row 14f is other-end-side path row. In the nozzle row 15, the path row 15c is the one-end-side path row and the path row 15g is other-end-side path row. In the nozzle row 16, the path row 16d is the one-end-side path row and the path row 16h is other-end-side path row.

In addition, in each of the four nozzle rows 13 to 16, a given ink-ejecting path row disposed between the one-end-side path row and the other-end-side path row in the sub-scanning direction is defined as a specific path row. In this embodiment, the path row 13c is the specific path row in the nozzle row 13, the path row 14d is the specific path row in the nozzle row 14, the path row 15e is the specific path row in the nozzle row 15, and the path row 16f is the specific path row in the nozzle row 16.

In the nozzle row 13, the amount of ink ejected by the path row 13c that is the specific path row is larger than the amount of ink ejected by each of the path rows 13a. 13b, 13d, and 13e that are the ink-ejecting path rows not including the path row 13c. In the nozzle row 14, the amount of ink ejected by the path row 14d that is the specific path row is larger than the amount of ink ejected by each of the path rows 14b, 14c. 14e, and 14f that are the ink-ejecting path rows not including the path row 14d. In the nozzle row 15, the amount of ink ejected by the path row 15e that is the specific path row is larger than the amount of ink ejected by each of the path rows 15c. 15d. 15f, and 15g that are the ink-ejecting path rows not including the path row 15e. In the nozzle row 16, the amount of ink ejected by the path row 16f that is the specific path row is larger than the amount of ink ejected by each of the path rows 16d. 16e. 16g, and 16h that are the ink-ejecting path rows not including the path row 16f.

In this embodiment, the path row 13a that is the one-end-side path row of the nozzle row 13, the path row 14b that is the one-end-side path row of the nozzle row 14, the path row 15c that is the one-end-side path row of the nozzle row 15, and the path row 16d that is the one-end-side path row of the nozzle row 16 are located shifted to each other in the front-to-rear direction. In short, respective one-end-side path rows of the four nozzle rows 13 to 16 are located shifted to each other in the sub-scanning direction. Specifically, the path rows 13a, 14b, 15c, and 16d are arranged in the alphabetical order from the rear side to the front side in the front-to-rear direction. Respective other-end-side path rows of the four nozzle rows 13 to 16 are too located shifted to each other in the sub-scanning direction.

In this embodiment, the path row 13c that is the specific path row of the nozzle row 13, the path row 14d that is the specific path row of the nozzle row 14, the path row 15e that is the specific path row of the nozzle row 15, and the path row 16f that is the specific path row of the nozzle row 16 are located shifted to each other in the front-to-rear direction. In short, respective specific path rows of the four nozzle rows 13 to 16 are located shifted to each other in the sub-scanning direction. Specifically, the path rows 13c, 14d. 15e, and 16f are arranged in the alphabetical order from the rear side to the front side in the front-to-rear direction. In other words, respective specific path rows of the four nozzle rows 13 to 16 are shifted in the sub-scanning direction in the order in which respective one-end-side path rows of the four nozzle rows 13 to 16 are shifted.

### (Printing Method for Print Medium)

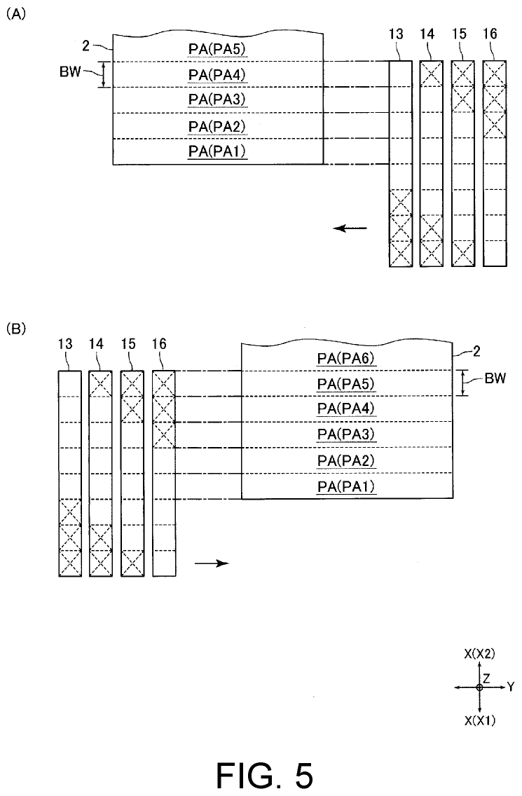

FIGS. 4 to 7 are diagrams for explaining an operation the printer 1 shown in FIG. 1 carries out during printing. (A) of FIG. 8 is a diagram for explaining the order of landing of jets of ink on specific parts of segmented printing regions PA1 and PA2 shown in FIGS. 4 to 7.

A printing region, which is a region where printing is performed on the print medium 2, is composed of a plurality of segmented printing regions PA segmented at the bandwidth BW in the front-to-rear direction. In the following description, when each of 10 segmented printing regions PA (a string of 10 segmented printing regions PA lined up in the front-to rear direction) shown in FIGS. 4 to 7 is shown separately, these 10 segmented regions PA are referred to as segmented printing regions PA1 to PA10. The segmented printing regions PA1 to PA10 are arranged in increasing order from the front side to the rear side. In the following description, ink ejected by the nozzle row 13 is referred to as “C”, ink ejected by the nozzle row 14 is referred to as “M”, ink ejected by the nozzle row 15 is referred to as “Y”, and ink ejected by the nozzle row 16 is referred to as “K”.

When printing is performed on the print medium 2, for example, the print medium 2 is fed first until the segmented printing region PA1 is located at the same position at which the path rows 13a, 14a, 15a, 16a are located in the front-to-rear direction (see (A) of FIG. 4). Subsequently, as the carriage 8 is moved to one side in the left-to-right direction, ink is ejected from the path row 13a onto the whole or a part of the segmented printing region PA1.

Subsequently, the print medium 2 is fed until the segmented printing region PA2 is located at the same position at which the path rows 13a, 14a, 15a, 16a are located in the front-to-rear direction (see (B) of FIG. 4). In other words, the print medium 2 is fed to the front side by the distance equal to the bandwidth BW until the segmented printing region PA1 is located at the same position at which the path rows 13b, 14b, 15b, and 16b are located in the front-to-rear direction. Subsequently, as the carriage 8 is moved to the other side in the left-to-right direction, ink is ejected from the path row 13a onto the whole or a part of the segmented printing region PA2 and is ejected from the path rows 13b and 14b onto the whole or a part of the segmented printing region PA1. At this time, on a specific part of the segmented printing region PA1, jets of ink land in the order of “C, M”.

Subsequently, the print medium 2 is fed to the front side by the distance equal to the bandwidth BW until the segmented printing region PA3 is located at the same position at which the path rows 13a, 14a, 15a, and 16a are located in the front-to-rear direction (see (C) of FIG. 4). Subsequently, as the carriage 8 is moved to the one side in the left-to-right direction, ink is ejected from the path row 13a onto the whole or a part of the segmented printing region PA3, is ejected from the path rows 13b and 14b onto the whole or a part of the segmented printing region PA2, and is ejected from the path rows 13c, 14c, and 15c onto the whole or a part of the segmented printing region PA1. At this time, jets of ink land in the order of “Y, M, C” on a specific part of the segmented printing region PA1 and land in the order of “M, C” on a specific part of the segmented printing region PA2.

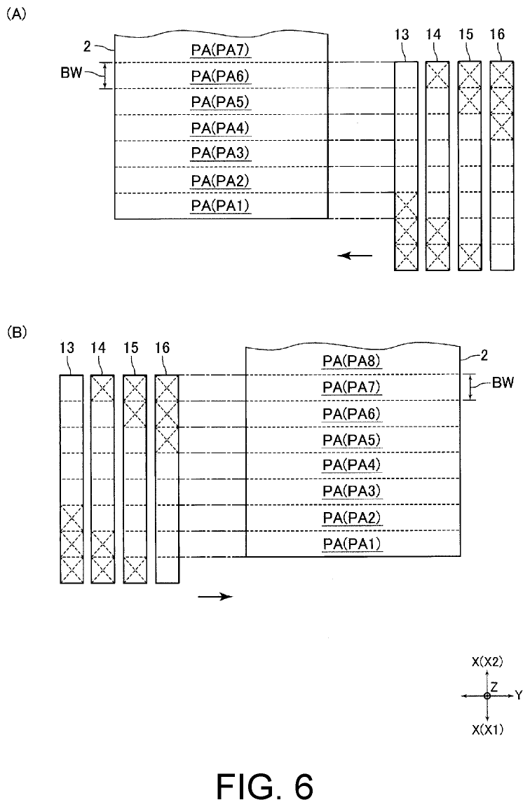

Subsequently, the print medium 2 is fed until the segmented printing region PA4 is located at the same position at which the path rows 13a, 14a, 15a, 16a are located in the front-to-rear direction (see (A) of FIG. 5). Subsequently, as the carriage 8 is moved to the other side in the left-to-right direction, ink is ejected from the path row 13a onto the whole or a part of the segmented printing region PA4, is ejected from the path rows 13b and 14b onto the whole or a part of the segmented printing region PA3, is ejected from the path rows 13c, 14c, and 15c onto the whole or a part of the segmented printing region PA2, and is ejected from the path rows 13d, 14d, 15d, and 16d onto the whole or a part of the segmented printing region PA1. At this time, jets of ink land in the order of “C, M, Y, K” on a specific part of the segmented printing region PA1, land in the order of “C, M, Y” on a specific part of the segmented printing region PA2, and land in the order of “C, M” on a specific part of the segmented printing region PA3.

Subsequently, the print medium 2 is fed until the segmented printing region PA5 is located at the same position at which the path rows 13a, 14a, 15a, 16a are located in the front-to-rear direction (see (B) of FIG. 5). Subsequently, as the carriage 8 is moved to the one side in the left-to-right direction, ink is ejected from the path row 13a onto the whole or a part of the segmented printing region PA5, is ejected from the path rows 13b and 14b onto the whole or a part of the segmented printing region PA4, is ejected from the path rows 13c, 14c, and 15c onto the whole or a part of the segmented printing region PA3, is ejected from the path rows 13d, 14d, 15d, and 16d onto the whole or a part of the segmented printing region PA2, and is ejected from the path rows 13e, 14e, 15e, and 16e onto the whole or a part of the segmented printing region PA1. At this time, jets of ink land in the order of “K, Y, M, C” on a specific part of the segmented printing region PA1 and a specific part of the segmented printing region PA2, land in the order of “Y, M, C” on a specific part of the segmented printing region PA3, and land in the order of “M, C” on a specific part of the segmented printing region PA4.

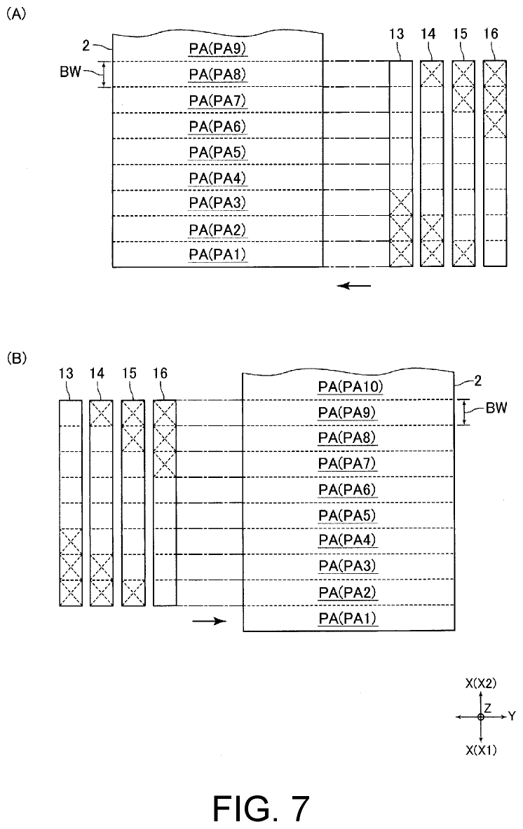

Subsequently, the print medium 2 is fed until the segmented printing region PA6 is located at the same position at which the path rows 13a, 14a, 15a, 16a are located in the front-to-rear direction (see (A) of FIG. 6). Subsequently, as the carriage 8 is moved to the other side in the left-to-right direction, ink is ejected from the path row 13a onto the whole or a part of the segmented printing region PA6, is ejected from the path rows 13b and 14b onto the whole or a part of the segmented printing region PA5, is ejected from the path rows 13c, 14c, and 15c onto the whole or a part of the segmented printing region PA4, is ejected from the path rows 13d, 14d, 15d, and 16d onto the whole or a part of the segmented printing region PA3, is ejected from the path rows 13e, 14e, 15e, and 16e onto the whole or a part of the segmented printing region PA2, and is ejected from the path rows 14f, 15f, and 16f onto the whole or a part of the segmented printing region PA1.

At this time, jets of ink land in the order of “M, Y, K” on a specific part of the segmented printing region PA1, land in the order of “C, M, Y, K” on a specific part of the segmented printing region PA2 and on a specific part of the segmented printing region PA3, land in the order of “C, M, Y” on a specific part of the segmented printing region PA4, and land in the order of “C, M” on a specific part of the segmented printing region PA5.

Subsequently, the print medium 2 is fed until the segmented printing region PA7 is located at the same position at which the path rows 13a, 14a, 15a, 16a are located in the front-to-rear direction (see (B) of FIG. 6). Subsequently, as the carriage 8 is moved to the one side in the left-to-right direction, ink is ejected from the path row 13a onto the whole or a part of the segmented printing region PA7, is ejected from the path rows 13b and 14b onto the whole or a part of the segmented printing region PA6, is ejected from the path rows 13c, 14c, and 15c onto the whole or a part of the segmented printing region PA5, is ejected from the path rows 13d, 14d, 15d, and 16d onto the whole or a part of the segmented printing region PA4, is ejected from the path rows 13e, 14e, 15e, and 16e onto the whole or a part of the segmented printing region PA3, is ejected from the path rows 14f, 15f, and 16f onto the whole or a part of the segmented printing region PA2, and is ejected from the path rows 15g and 16g onto the whole or a part of the segmented printing region PA1.

At this time, jets of ink land in the order of “K, Y” on a specific part of the segmented printing region PA1, land in the order of “K, Y, M” on a specific part of the segmented printing region PA2, land in the order of “K, Y, M, C” on a specific part of the segmented printing region PA3 and on a specific part of the segmented printing region PA4, land in the order of “Y, M, C” on a specific part of the segmented printing region PA5, and land in the order of “M, C” on a specific part of the segmented printing region PA6.

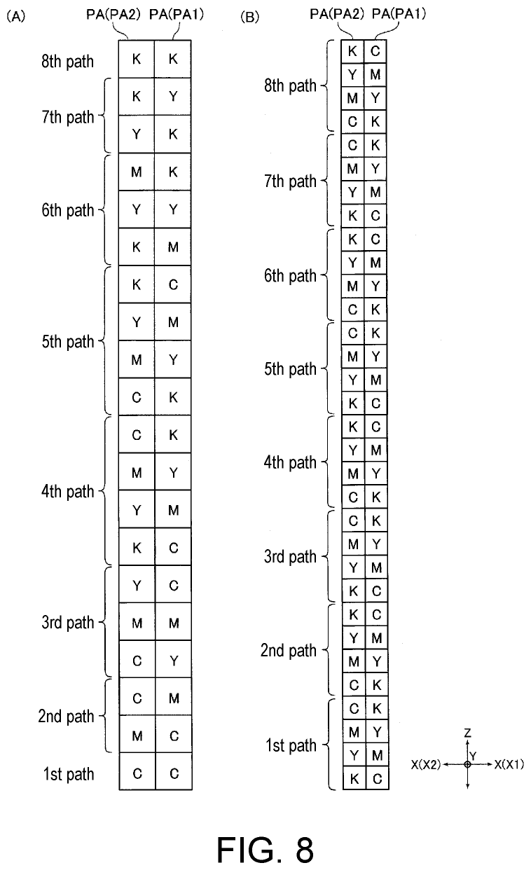

Subsequently, the print medium 2 is fed until the segmented printing region PA8 is located at the same position at which the path rows 13a, 14a, 15a, 16a are located in the front-to-rear direction (see (A) of FIG. 7). Subsequently, as the carriage 8 is moved to the other side in the left-to-right direction, ink is ejected from the path row 13a onto the whole or a part of the segmented printing region PA8, is ejected from the path rows 13b and 14b onto the whole or a part of the segmented printing region PA7, is ejected from the path rows 13c, 14c, and 15c onto the whole or a part of the segmented printing region PA6, is ejected from the path rows 13d, 14d, 15d, and 16d onto the whole or a part of the segmented printing region PA5, is ejected from the path rows 13e, 14e, 15e, and 16e onto the whole or a part of the segmented printing region PA4, is ejected from the path rows 14f, 15f, and 16f onto the whole or a part of the segmented printing region PA3, is ejected from the path rows 15g and 16g onto the whole or a part of the segmented printing region PA2, and is ejected from the path row 16f onto the whole or a part of the segmented printing region PA1.

At this time, jets of ink land in the order of “Y, K” on a specific part of the segmented printing region PA2, land in the order of “M, Y, K” on a specific part of the segmented printing region PA3, land in the order of “C, M, Y, K” on a specific part of the segmented printing region PA4 and on a specific part of the segmented printing region PA5, land in the order of “C, M, Y” on a specific part of the segmented printing region PA6, and land in the order of “C, M” on a specific part of the segmented printing region PA7. When ink has been ejected from the path row 16f onto the segmented printing region PA1, printing in the segmented printing region PA1 ends.

Subsequently, the print medium 2 is fed until the segmented printing region PA9 is located at the same position at which the path rows 13a, 14a, 15a, 16a are located in the front-to-rear direction (see (B) of FIG. 7). Subsequently, as the carriage 8 is moved to the one side in the left-to-right direction, ink is ejected from the path row 13a onto the whole or a part of the segmented printing region PA9, is ejected from the path rows 13b and 14b onto the whole or a part of the segmented printing region PA8, is ejected from the path rows 13c, 14c, and 15c onto the whole or a part of the segmented printing region PA7, is ejected from the path rows 13d, 14d, 15d, and 16d onto the whole or a part of the segmented printing region PA6, is ejected from the path rows 13e, 14e, 15e, and 16e onto the whole or a part of the segmented printing region PA5, is ejected from the path rows 14f, 15f, and 16f onto the whole or a part of the segmented printing region PA4, is ejected from the path rows 15g and 16g onto the whole or a part of the segmented printing region PA3, and is ejected from the path row 16f onto the whole or a part of the segmented printing region PA2.

At this time, jets of ink land in the order of “K, Y” on a specific part of the segmented printing region PA3, land in the order of “K, Y, M” on a specific part of the segmented printing region PA4, land in the order of “K, Y, M, C” on a specific part of the segmented printing region PA5 and on a specific part of the segmented printing region PA6, land in the order of “Y, M, C” on a specific part of the segmented printing region PA7, and land in the order of “M, C” on a specific part of the segmented printing region PA8. When ink has been ejected from the path row 16f onto the segmented printing region PA2, printing in the segmented printing region PA2 ends.

In this manner, the above operations are repeated to perform printing on the print medium 2. On specific parts of the segmented printing region PA1 and on specific parts of segmented printing region PA2 that are located at the same positions at which the specific parts of the segmented printing region PA1 are located in the left-to-right direction (i.e., specific parts of segmented printing region PA2 that are adjacent to the specific parts of the segmented printing region PA1 in the front-to-rear direction), jets of ink land in such order as shown in (A) of FIG. 8.

### Major Effects of this Embodiment

As described above, in this embodiment, each of the nozzle rows 13 to 16 is composed of the ink-ejecting path rows and the no-ink-ejecting path rows, and the four nozzle rows 13 to 16 each have the same number of ink-ejecting path rows. In this embodiment, the path row 13a, the path row 14b, the path row 15c, and the path row 16d, which are respective one-end-side path rows of the four nozzle rows 13 to 16, are located shifted to each other in the front-to-rear direction. Because of this configuration, according to this embodiment, on the specific parts of the segmented printing region PA1 and on the specific parts of segmented printing region PA2 that are located at the same positions at which the specific parts of the segmented printing region PA1 are located in the left-to-right direction, for example, jets of ink land in the order shown in (A) of FIG. 8, as described above.

In other words, in this embodiment, the order of landing of jets of ink in the segmented printing region PA1 and the same in the segmented printing region PA2 after completion of printing by the multi-path method do not match completely, but in an overall view of the segmented printing region PA1 and the segmented printing region PA2 after completion of printing by the multi-path method, the order of landing of jets of ink in the segmented printing region PA1 and the same in the segmented printing region PA2 can be bright closer to each other, as shown in (A) of FIG. 8.

In this embodiment, therefore, a difference between a color shade in the segmented printing region PA1 after completion of printing and a color shade in the segmented printing region PA2 after completion of printing can be reduced. In other words, in this embodiment, a difference in color shade between two segmented printing regions PA adjacent to each other in the front-to-rear direction, the difference resulting after completion of printing, can be reduced. Hence, in this embodiment, the occurrence of color changing, i.e., creation of a difference in color shade between segmented printing regions adjacent to each other in the front-to-rear direction, can be prevented and therefore the print quality of the printer 1 can be ensured.

Particularly, in this embodiment, the path row 13c, the path row 14d, the path row 15e, and the path row 16f, which are the specific path rows each ejecting the largest amount of ink in each nozzle row, are located shifted to each other in the front-to-rear direction. In addition, in this embodiment, the path rows 13c, 14d, 15e, and 16f are arranged in the alphabetical order from the rear side to the front side in the front-to-rear direction, and are shifted in the order in which the path rows 13a, 14b, 15c, and 16d are shifted.

As a result, in this embodiment, in an overall view of the segmented printing region PA1 and the segmented printing region PA2 after completion of printing by the multi-path method, the order of landing of jets of ink in the segmented printing region PA1 and the same in the segmented printing region PA2 can be further bright closer to each other. In this embodiment, therefore, a difference between a color shade in the segmented printing region PA1 after completion of printing and a color shade in the segmented printing region PA2 after completion of printing can be further reduced. Hence, in this embodiment, the occurrence of color changing, i.e., creation of a difference in color shade between segmented printing regions PA adjacent to each other in the front-to-rear direction, can be further prevented and therefore the print quality of the printer 1 can be improved.

When all the path rows 13a to 13h, 14a to 14h, 15a to 15h, and 16a to 16h are all ink-ejecting path rows, on the specific parts of the segmented printing region PA1 and on the specific parts of segmented printing region PA2 that are located at the same positions at which the specific parts of the segmented printing region PA1 are located in the left-to-right direction, for example, jets of ink land in such order as shown in (B) of FIG. 8. In this case, for example, when the path rows 13a to 16a arranged at the same position in the front-to-rear direction eject the same amount of ink, the path rows 13b to 16b arranged at the same position in the front-to-rear direction eject the same amount of ink, the path rows 13c to 16c arranged at the same position in the front-to-rear direction eject the same amount of ink, the path rows 13d to 16d arranged at the same position in the front-to-rear direction eject the same amount of ink, the path rows 13e to 16e arranged at the same position in the front-to-rear direction eject the same amount of ink, the path rows 13f to 16f arranged at the same position in the front-to-rear direction eject the same amount of ink, the path rows 13g to 16g arranged at the same position in the front-to-rear direction eject the same amount of ink, and the path rows 13h to 16h arranged at the same position in the front-to-rear direction eject the same amount of ink, it may create a difference between a color shade in the segmented printing region PA1 after completion of printing and a color shade in the segmented printing region PA2 after completion of printing.

In this embodiment, the path row 13a, the path row 14b, the path row 15c, and the path row 16d are located shifted to each other in the front-to-rear direction. Because of this arrangement, the number of nozzle rows 13 to 16 that eject ink is reduced in a printing process on the 1st to 3rd paths and in a printing process on the 6th to 8th paths among printing processes carried out on 8 paths in each segmented printing region PA. Thus, in this embodiment, the occurrence of color mixing is prevented in the printing process on the 1st to 3rd paths and in the printing process on the 6th to 8th paths. In addition, in this embodiment, because the path row 13c, the path row 14d, the path row 15e, and the path row 16f, which each eject the largest amount of ink in each nozzle row, are located shifted to each other in the front-to-rear direction, the occurrence of color mixing can be prevented also in a printing process on the 4th and 5th paths and can be further prevented in the printing process on the 1st to 3rd paths and in the printing process on the 6th to 8th paths.

It should be noted that by locating the nozzle rows 13 to 16 shifted to each other in the front-to-rear direction (that is, locating the heads 3 to 6 shifted to each other in the front-to-rear direction), the order of landing of ink in the segmented printing region PA1 and the same in the segmented printing region PA2 after completion of printing by the multi-path method can be completely matched. In this case, however, the size of the carriage 8 increases in the front-to-rear direction. On top of that, in this case, printing on the print medium 2 takes much time. In this embodiment, in contrast, the nozzle rows 13 to 16 are arranged at the same position in the front-to-rear direction and therefore such problems do not arise.

### (Modification of Order of Arrangement of Inkjet Heads)

In the embodiment described above, the four heads 3 to 6 are lined up in increasing order from the one side to the other side in the left-to-right direction. However, the four heads 3 to 6 may be lined up in any given order from the one side to the other side in the left-to-right direction. This means that the four nozzle rows 13 to 16 may be lined up in any given order from the one side to the other side in the left-to-right direction. Also in modifications described below, the four nozzle rows 13 to 16 may be lined up in any given order from the one side to the other side in the left-to-right direction.

### (First Modification of Changing Color of Ink Ejected by Inkjet Heads)

In the embodiment described above, the color of ink ejected by the nozzle row 13 may be yellow (Y), that of ink ejected by the nozzle row 14 may be cyan (C), that of ink ejected by the nozzle row 15 may be magenta (M), and that of ink ejected by the nozzle row 16 may be black (K). In this case, black ink of a relatively dark color greater in amount than yellow ink of a relatively light color can be located on a side closer to the surface of an image having been printed. An image with a clear outline or the like (e.g., an image with a clear edge), therefore, can be printed on the print medium 2.

In this case, the nozzle row 16 is a dark ink nozzle row that ejects a color ink of a relatively dark color, and the nozzle row 13 is a light ink nozzle row that ejects a color ink of a relatively light color. In other words, the four heads 3 to 6 have the dark ink nozzle row and the light ink nozzle row. The one-end-side path row (path row 16d) of the nozzle row 16, which is the dark ink nozzle row, is disposed closer to the front side than the one-end-side path row (path row 13a) of the nozzle row 13, which is the light ink nozzle row.

In the embodiment described above, the color of ink ejected by the nozzle row 13 may be light cyan (Lc), that of ink ejected by the nozzle row 14 may be light magenta (Lm), that of ink ejected by the nozzle row 15 may be cyan (C), and that of ink ejected by the nozzle row 16 may be magenta (M). In this case, cyan and magenta inks of relatively dark colors greater in amount than light cyan and light magenta inks of relatively light colors can be located on a side closer to the surface of an image having been printed, and therefore an image with a clear outline or the like can be printed on the print medium 2.

In this case, the nozzle rows 15 and 16 are dark ink nozzle rows that eject color inks of relatively dark colors, and the nozzle rows 13 and 14 are light ink nozzle rows that eject color inks of relatively light colors. In other words, the four heads 3 to 6 have the dark ink nozzle row and the light ink nozzle row. The one-end-side path rows (path rows 15c and 16d) of the nozzle rows 15 and 16, which are the dark ink nozzle rows, are disposed closer to the front side than the one-end-side path rows (path rows 13a and 14b) of the nozzle rows 13 and 14, which are the light ink nozzle row heads.

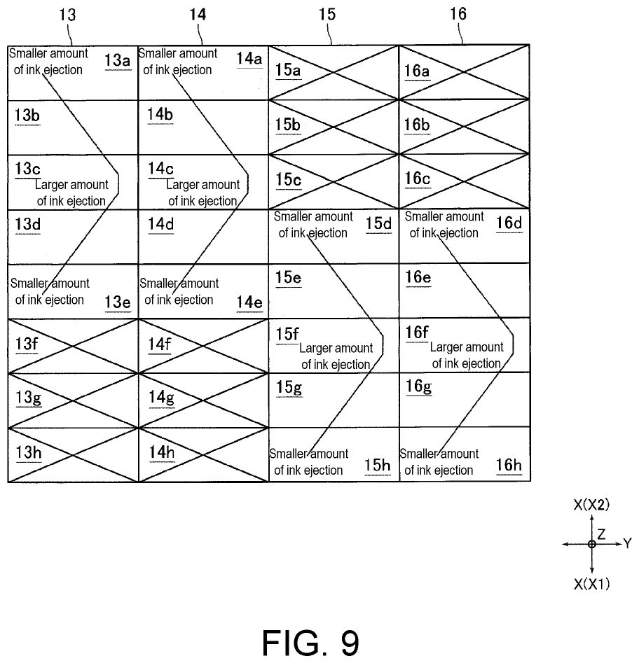

When the color of ink ejected by the nozzle row 13 is light cyan (Lc), that of ink ejected by the nozzle row 14 is light magenta (Lm), that of ink ejected by the nozzle row 15 is cyan (C), and that of ink ejected by the nozzle row 16 is magenta (M), for example, in a configuration in which the path rows 13a to 13e, 14a to 14e, 15d to 15h, and 16d to 16h are ink-ejecting path rows, the path rows 13f to 13h, 14f to 14h, 15a to 15c, and 16a to 16c are no-ink-ejecting path rows, and the path rows 13c, 14c, 15f, and 16f are specific path rows which each eject the largest amount of ink in each nozzle row, as shown in FIG. 9, cyan and magenta inks of relatively dark colors greater in amount than light cyan and light magenta inks of relatively light colors can be located on a side closer to the surface of an image having been printed, and therefore an image with a clear outline or the like can be printed on the print medium 2.

### Second Modification of Changing Color of Ink Ejected by Inkjet Heads

In the embodiment described above, the color of ink ejected by the nozzle row 13 may be black (K), that of ink ejected by the nozzle row 14 may be magenta (M), that of ink ejected by the nozzle row 15 may be cyan (C), and that of ink ejected by the nozzle row 16 may be yellow (Y). In this case, yellow ink of a relatively light color greater in amount than black ink of a relatively dark color can be located on a side closer to the surface of an image having been printed. As a result, a fuzzy image, in which the grainy texture of ink is suppressed, can be printed on the print medium 2.

In this case, the nozzle row 13 is a dark ink nozzle row that ejects color ink of a relatively dark color, and the nozzle row 16 is a light ink nozzle row that ejects color ink of a relatively light color. The one-end-side path row (path row 16d) of the nozzle row 16, which is the light ink nozzle row, is disposed closer to the front side than the one-end-side path row (path row 13a) of the nozzle row 13, which is the dark ink nozzle row.

In the embodiment described above, the color of ink ejected by the nozzle row 13 may be magenta (M), that of ink ejected by the nozzle row 14 may be cyan (C), that of ink ejected by the nozzle row 15 may be light magenta (Lm), and that of ink ejected by the nozzle row 16 may be light cyan (Lc). In this case, light magenta and light cyan inks of relatively light colors greater in amount than magenta and cyan inks of relatively dark colors can be located on a side closer to the surface of an image having been printed, and therefore a fuzzy image, in which the grainy texture of ink is suppressed, can be printed on the print medium 2.

In this case, the nozzle rows 13 and 14 are dark ink nozzle rows that eject color inks of relatively dark colors, and the nozzle rows 15 and 16 are light ink nozzle rows that eject color inks of relatively light colors. The one-end-side path rows (path rows 15c and 16d) of the nozzle rows 15 and 16, which are the light ink nozzle rows, are disposed closer to the front side than the one-end-side path rows (path rows 13a and 14b) of the nozzle rows 13 and 14, which are the dark ink nozzle rows.

When the color of ink ejected by the nozzle row 13 is magenta (M), that of ink ejected by the nozzle row 14 is cyan (C), that of ink ejected by the nozzle row 15 is light magenta (Lm), and that of ink ejected by the nozzle row 16 is light cyan (Lc), for example, in the configuration in which the path rows 13a to 13e, 14a to 14e, 15d to 15h, and 16d to 16h are ink-ejecting path rows, the path rows 13f to 13h, 14f to 14h, 15a to 15c, and 16a to 16c are no-ink-ejecting path rows, and the path rows 13c, 14c, 15f, and 16f are specific path rows which each eject the largest amount of ink in each nozzle row, as shown in FIG. 9, light magenta and light cyan inks of relatively light colors greater in amount than magenta and cyan inks of relatively dark colors can be located on a side closer to the surface of an image having been printed, and therefore a fuzzy image, in which the grainy texture of ink is suppressed, can be printed on the print medium 2.

### (First Modification of Nozzle Rows)

In the embodiment described above, respective amounts of ink ejected by the path rows 13a to 13e may be equal to each other, the same ejected by the path rows 14b to 14f may be equal to each other, the same ejected by the path rows 15c to 15g may be equal to each other, and the same ejected by the path rows 16d to 16g may be equal to each other.

### (Second Modification of Nozzle Rows)

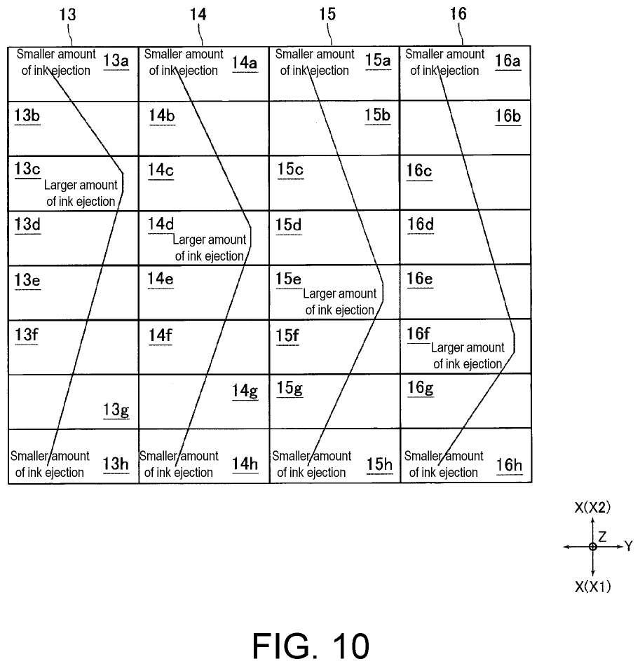

FIG. 10 is a schematic diagram for explaining a configuration of nozzle rows 13 to 16 according to another embodiment of the present invention.

In the embodiment described above, the path rows 13a to 13h, 14a to 14h, 15a to 15h, and 16a to 16h may all serve as ink-ejecting path rows, as shown in FIG. 10. In this case, for example, in the same manner as in the above-described embodiment, the path rows 13c, 14d, 15e, and 16f are the specific path rows that each eject the largest amount of ink in each nozzle row, and respective specific path rows of the four nozzle rows 13 to 16 are located shifted to each other in the front-to-rear direction.

In this modification, because respective specific path rows of the four nozzle rows 13 to 16 are located shifted to each other in the front-to-rear direction, in an overall view of the segmented printing region PA1 and the segmented printing region PA2 after completion of printing by the multi-path method, the order of landing of jets of ink in the segmented printing region PA1 and the same in the segmented printing region PA2 can be bright closer to each other. A difference between a color shade in the segmented printing region PA1 after completion of printing and a color shade in the segmented printing region PA2 after completion of printing, therefore, can be reduced. In other words, a difference in color shade between two segmented printing regions PA adjacent to each other in the front-to-rear direction, the difference resulting after completion of printing, can be reduced. Hence the occurrence of color changing, i.e., creation of a difference in color shade between segmented printing regions PA adjacent to each other in the front-to-rear direction, can be prevented and therefore the print quality of the printer 1 can be ensured.

In this modification, because respective specific path rows of the four nozzle rows 13 to 16, the specific path rows each ejecting the largest amount of ink in each nozzle row, are located shifted to each other in the front-to-rear direction, the occurrence of color mixing can be prevented when the specific path rows eject ink.

### (Third Modification of Nozzle Rows)

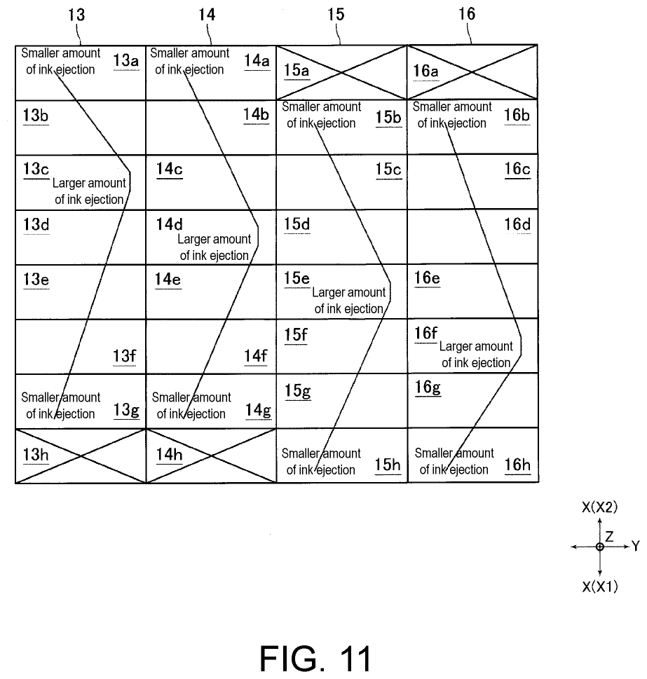

FIG. 11 is a schematic diagram for explaining a configuration of nozzle rows 13 to 16 according to still another embodiment of the present invention.

In the embodiment described above, for example, as shown in FIG. 11, the path rows 13a to 13g, 14a to 14g, 15b to 15h, and 16b to 16h may be ink-ejecting path rows, the path rows 13h, 14h, 15a, and 16a may be no-ink-ejecting path rows, the path row 13a that is the one-end-side path row of the nozzle row 13 and the path row 14a that is the one-end-side path row of the nozzle row 14 may be located at the same position in the front-to-rear direction, and the path row 15b that is the one-end-side path row of the nozzle row 15 and the path row 16b that is the one-end-side path row of the nozzle row 16 may be located at the same position in the front-to-rear direction.

In this case, for example, the path rows 13c, 14d, 15e, and 16f are the specific path rows that each eject the largest amount of ink in each nozzle row, as are in the above-described embodiment. In this case, because respective specific path rows of the four nozzle rows 13 to 16 are located shifted to each other in the front-to-rear direction, in an overall view of the segmented printing region PA1 and the segmented printing region PA2 after completion of printing by the multi-path method, the order of landing of jets of ink in the segmented printing region PA1 and the same in the segmented printing region PA2 can be bright closer to each other. A difference between a color shade in the segmented printing region PA1 after completion of printing and a color shade in the segmented printing region PA2 after completion of printing, therefore, can be reduced.

### (Fourth Modification of Nozzle Rows)

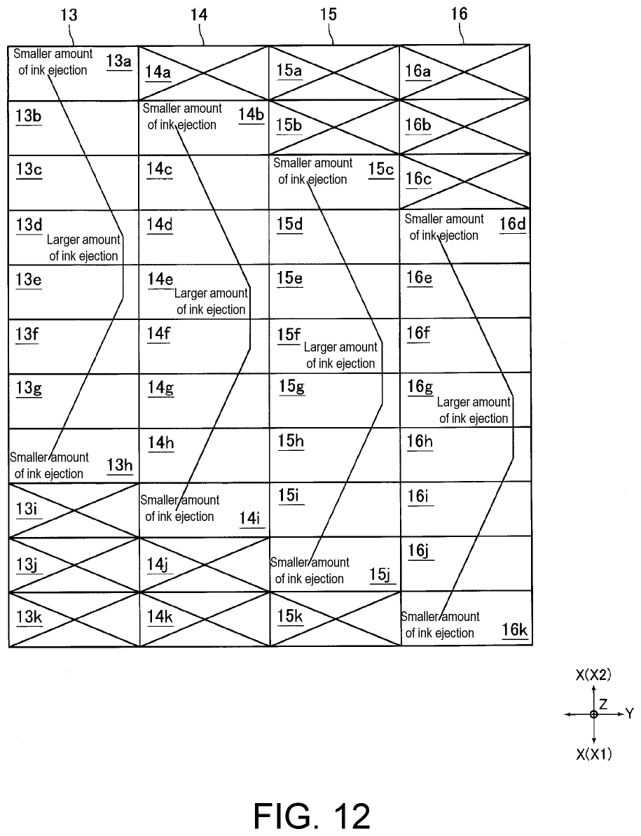

FIG. 12 is a schematic diagram for explaining a configuration of nozzle rows 13 to 16 according to still another embodiment of the present invention.

In the embodiment described above, the printer 1 may perform printing on the print medium 2 in multiple paths other than eight paths. For example, the printer 1 may perform printing on the print medium 2 in 11 paths. In this case, for example, as shown in FIG. 12, the nozzle row 13 is composed of 11 path rows 13a to 13k, the nozzle row 14 is composed of 11 path rows 14a to 14k, the nozzle row 15 is composed of 11 path rows 15a to 15k, and the nozzle row 16 is composed of 11 path rows 16a to 16k.

In the example shown in FIG. 12, the path rows 13a to 13h, 14b to 14i, 15c to 15j, and 16d to 16k are ink-ejecting path rows, and the path rows 13i to 13k, 14a, 14j, 14k, 15a, 15b, 15k, and 16a to 16c are no-ink-ejecting path rows. In other words, the nozzle rows 13 to 16 each include eight ink-ejecting path rows. In this case, the resolution of an image to be printed on the print medium 2 can be made substantially the same as the resolution of the image that is printed on the print medium 2 by the conventional 8-path method.

In the example shown in FIG. 12, for example, the path rows 13d. 13e. 14e, 14f. 15f. 15g. 16g, and 16h are the specific path rows that each eject the largest amount of ink in each nozzle row, and respective specific path rows of the four nozzle rows 13 to 16 are located shifted to each other in the front-to-rear direction. The printer 1 may perform printing on the print medium 2, for example, in 16 paths or in 32 paths. When the printer 1 performs printing on the print medium 2 in 16 paths, the nozzle rows 13 to 16 each have, for example, 16 path rows. When the printer 1 performs printing on the print medium 2 in 32 paths, the nozzle rows 13 to 16 each have, for example, 32 path rows.

### Other Embodiments

The embodiments and modifications described above are examples of preferred embodiments of the present invention. The preferred embodiments are, however, not limited to the above embodiments and modification but may be modified in various forms within a range in which the substance of the present invention is not changed.

In the embodiments and modifications described above, when the nozzle rows 13 to 16 have the specific path rows, the number of ink-ejecting path rows the nozzle rows 13 to 16 each have may be three or more. In the embodiments and modifications described above, the nozzle rows 13 to 16 each include one specific path row in most cases. The nozzle rows 13 to 16, however, may each include two or more specific path rows. For example, the nozzle rows 13 to 16 may each include two specific path rows, as do in the modification shown in FIG. 12. For example, in the embodiments described above, when the nozzle rows 13 to 16 are each composed of 9 or more path rows, respective specific path rows of the nozzle rows 13 to 16 may be located at the same position in the front-to-rear direction.

In the embodiments and modifications described above, the number of heads mounted on the carriage 8 may be one. In this case, one head has four nozzle rows 13 to 16. The number of heads mounted on the carriage 8 may be two or three. When the number of heads mounted on the carriage 8 is two, for example, one of the two heads has two nozzle rows 13 and 14 as the other of the two heads has two nozzle rows 15 and 16.

In the embodiments and modifications described above, the number of heads mounted on the carriage 8 may be five or more. In other words, the number of heads the printer 1 has may be M, which is 1 or more. In this case, the carriage 8 carries M heads mounted thereon. In this case, the M heads mounted on the carriage 8 may have N nozzle rows in total, N being 2 or more. When the M heads mounted on the carriage 8 have N nozzle rows in total. N being 2 or more, and the nozzle rows have specific path rows, each nozzle row may be composed of N+2 or more path rows. In this configuration, respective specific path rows of the N nozzle rows can be located shifted to each other in the front-to-rear direction.

When the M heads mounted on the carriage 8 have N nozzle rows in total, N being 2 or more, and the nozzle rows have no specific path rows (that is, ink-ejecting path rows in each of the N nozzle rows each eject the same amount of ink), each nozzle row may be composed of N or more path rows. In this configuration, respective one-end-side path rows of the N nozzle rows can be located shifted to each other in the front-to-rear direction. In the case where the M heads mounted on the carriage 8 have N nozzle rows in total, N being 2 or more, and the nozzle rows have no specific path rows, when each nozzle row is composed of N path rows, the number of ink-ejecting path rows each of the N nozzle rows has is one.

### REFERENCE SIGNS LIST

1 Printer (inkjet printer)
2 Print medium
3 to 6 Head (inkjet head, dark ink head, light ink head)
8 Carriage
9 Carriage drive mechanism
12 Medium feeding mechanism (feeding mechanism)
13 to 16 Nozzle row
13a, 14b, 15d, 16e Path row (Ink-ejecting path row, one-end-side path row)
13b, 13d, 14c, 14e, 15d, 15f, 16e, 16g Path row (ink-ejecting path row)
13c, 14d, 15e, 16f Path row (ink-ejecting path row, specific path row)
13e, 14f, 15g, 16h Path row (ink-ejecting path row, other-end-side path row)
13f to 13h, 14a, 14g, 14h, 15a, 15b, 15h, 16a to 16c Path row (no-ink-ejecting path row)
BW Bandwidth
X Sub-scanning direction
X1 First direction
Y Main scanning direction
Z Vertical direction

1. An inkjet printer comprising:
M inkjet heads, M being 1 or more, that have a plurality of nozzles capable of ejecting ink toward a print medium;
a carriage carrying the M inkjet heads mounted thereon;
a carriage drive mechanism that moves the carriage in a main scanning direction; and
a feeding mechanism that feeds the print medium in a sub-scanning direction perpendicular to a vertical direction and the main scanning direction, relative to the carriage, wherein
the inkjet printer repeatedly carrying out an operation of moving the carriage to one side in the main scanning direction, an operation of feeding the print medium in the sub-scanning direction relative to the carriage, an operation of moving the carriage to the other side in the main scanning direction, and an operation of feeding the print medium in the sub-scanning direction relative to the carriage, thereby performing printing on the print medium by a multi-path method, wherein
each of the inkjet heads has a nozzle row composed of a plurality of the nozzles arranged in the sub-scanning direction, wherein
the M inkjet heads mounted on the carriage have N nozzle rows in total, N being 2 or more, wherein
the N nozzle rows are lined up in the main scanning direction and are arranged at the same position in the sub-scanning direction, wherein
each of the nozzle row is composed of a plurality of N or more path rows segmented at a given bandwidth in the sub-scanning direction, and is composed of ink-ejecting path rows that are the path rows that eject ink when printing is performed on the print medium and no-ink-ejecting path rows that are the path rows that do not eject ink when printing is performed on the print medium, wherein
when printing is performed on the print medium, the feeding mechanism feeds the print medium by a distance equal to the bandwidth in the sub-scanning direction, relative to the carriage, wherein
the N nozzle rows each have the same number of the ink-ejecting path rows, wherein
when the N nozzle rows each have a plurality of the ink-ejecting path rows, the ink-ejecting path rows are entirely arranged as a string of path rows in the sub-scanning direction in each of the N nozzle rows, and wherein
when the ink-ejecting path row disposed at an end on one side in the sub-scanning direction in each of the N nozzle rows is defined as a one-end-side path row, respective one-end-side path rows of the N nozzle rows are located shifted to each other in the sub-scanning direction.

2. The inkjet printer as set forth in claim 1, wherein
the nozzle row is composed of N+2 or more of the path rows and each of the N nozzle rows include three or more of the ink-ejecting path rows, wherein
in each of the N nozzle rows, when, among the plurality of ink-ejecting path rows, an ink-ejecting path row disposed at an end on the other side in the sub-scanning direction is defined as an other-end-side path row and a given ink-ejecting path row disposed between the one-end-side path row and the other-end-side path row in the sub-scanning direction is defined as a specific path row, in each of the N nozzle rows, an amount of ink ejected by the specific path row is larger than an amount of ink ejected by each of the other ink-ejecting path rows not including the specific path row and an amount of ink ejected by the ink-ejecting path row increases gradually as it goes from the one-end-side path row toward the specific path row but the amount of ink ejected by the ink-ejecting path row decreases gradually as it goes from the specific path row toward the other-end-side path row, and wherein
respective specific path rows of the N nozzle rows are located shifted to each other in the sub-scanning direction and are shifted in the same order in which respective one-end-side path rows of the N nozzle rows are shifted in the sub-scanning direction.

3. The inkjet printer as set forth in claim 1, wherein
when a side to which the print medium moves relative to the carriage is defined as a first direction side, the M inkjet heads have, as the nozzle rows, a dark ink nozzle row that ejects color ink of a relatively dark color and a light ink nozzle row that ejects color ink of a relatively light color, and wherein
the one-end-side path row of the dark ink nozzle row is disposed closer to the first direction side than the one-end-side path row of the light ink nozzle row.

4. The inkjet printer as set forth in claim 1, wherein
when a side to which the print medium moves relative to the carriage is defined as a first direction side, the M inkjet heads have, as the nozzle rows, a dark ink nozzle row that ejects color ink of a relatively dark color and a light ink nozzle row that ejects color ink of a relatively light color, and wherein
the one-end-side path row of the light ink nozzle row is disposed closer to the first direction side than the one-end-side path row of the dark ink nozzle row.

5. An inkjet printer comprising:
M inkjet heads, M being 1 or more, that have a plurality of nozzles capable of ejecting ink toward a print medium;
a carriage carrying the M inkjet heads mounted thereon;
a carriage drive mechanism that moves the carriage in a main scanning direction; and
a feeding mechanism that feeds the print medium in a sub-scanning direction perpendicular to a vertical direction and the main scanning direction, relative to the carriage, the inkjet printer repeatedly carrying out an operation of moving the carriage to one side in the main scanning direction, an operation of feeding the print medium in the sub-scanning direction relative to the carriage, an operation of moving the carriage to the other side in the main scanning direction, and an operation of feeding the print medium in the sub-scanning direction relative to the carriage, thereby performing printing on the print medium by a multi-path method, wherein
each of the inkjet heads has a nozzle row composed of a plurality of nozzles arranged in the sub-scanning direction, wherein
the M inkjet heads mounted on the carriage have N nozzle rows in total, N being 2 or more, wherein
the N nozzle rows are lined up in the main scanning direction and are arranged at the same position in the sub-scanning direction, wherein
each of the nozzle rows is composed of a plurality of N+2 or more path rows segmented at a given bandwidth in the sub-scanning direction, and has three or more ink-ejecting path rows that are the path rows that eject ink when printing is performed on the print medium, wherein
when printing is performed on the print medium, the feeding mechanism feeds the print medium by a distance equal to the bandwidth in the sub-scanning direction, relative to the carriage, wherein
in each of the N nozzle rows, when, among the plurality of ink-ejecting path rows, an ink-ejecting path row disposed at an end on one side in the sub-scanning direction is defined as a one-end-side path row, an ink-ejecting path row disposed at an end on the other side in the sub-scanning direction is defined as an other-end-side path row, and a given ink-ejecting path row disposed between the one-end-side path row and the other-end-side path row in the sub-scanning direction is defined as a specific path row, in each of the N nozzle rows, an amount of ink ejected by the specific path row is larger than an amount of ink ejected by each of the other ink-ejecting path rows not including the specific path row and an amount of ink ejected by the ink-ejecting path row increases gradually as it goes from the one-end-side path row toward the specific path row but the amount of ink ejected by the ink-ejecting path row decreases gradually as it goes from the specific path row toward the other-end-side path row, and wherein
respective specific path rows of the N nozzle rows are located shifted to each other in the sub-scanning direction.

6. The inkjet printer as set forth in claim 1, wherein
the M inkjet heads mounted on the carriage have four of the nozzle rows in total, the nozzle rows ejecting color inks different in color from each other.

7. The inkjet printer as set forth in claim 2, wherein
when a side to which the print medium moves relative to the carriage is defined as a first direction side, the M inkjet heads have, as the nozzle rows, a dark ink nozzle row that ejects color ink of a relatively dark color and a light ink nozzle row that ejects color ink of a relatively light color, and wherein
the one-end-side path row of the dark ink nozzle row is disposed closer to the first direction side than the one-end-side path row of the light ink nozzle row.

8. The inkjet printer as set forth in claim 2, wherein
when a side to which the print medium moves relative to the carriage is defined as a first direction side, the M inkjet heads have, as the nozzle rows, a dark ink nozzle row that ejects color ink of a relatively dark color and a light ink nozzle row that ejects color ink of a relatively light color, and wherein
the one-end-side path row of the light ink nozzle row is disposed closer to the first direction side than the one-end-side path row of the dark ink nozzle row.

9. The inkjet printer as set forth in claim 5, wherein
the M inkjet heads mounted on the carriage have four of the nozzle rows in total, the nozzle rows ejecting color inks different in color from each other.
